(19) United States
(12) Patent Application Publication
(10) Pub. No.: US 2010/0052847 A1
(43) Pub. Date: Mar. 4, 2010

(54) SYSTEMS AND METHODS TO ENHANCE TELEVISION VIEWING

(76) Inventor: Peter Mortensen, Lake Elsinore, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/547,763

(22) Filed: Aug. 26, 2009

Related U.S. Application Data
(60) Provisional application No. 61/093,356, filed on Sep. 1, 2008.

(51) Int. Cl. G06F 7/04; H04N 5/44; H04N 5/445

(52) U.S. Cl. 340/5.53; 348/553; 348/563; 348/734; 348/E05.103

(57) ABSTRACT

Systems and methods for enabling centralized environmental and television positional control to enhance the viewing experience. In one embodiment, an environmental controller is used to adjust or control lighting, window coverings, etc., and a television positional controller is used to adjust the position of the television.

### CROSS-REFERENCE TO RELATED APPLICATION

This application claims the benefit of provisional application Ser. No. 61/093,356 filed Sep. 1, 2008, which is fully incorporated herein by reference.

### FIELD

The present invention relates generally to televisions and, more particularly, to systems and methods that facilitate an enhanced viewing experience.

### BACKGROUND

The capabilities and features of televisions continue to expand and improve. Many televisions include features and capabilities that allow a user or operator to fine tune picture and audio performance, device setup and the like in order to provide the highest quality presentation for a given viewing environment and content to be viewed. As these capabilities become more affordable, more and more consumers will seek a true theater experience. However, as a user begins playing a program or movie, they often encounter glare from lighting or from windows, and other interferences with the program, and must get up and adjust the lighting and window coverings to improve the viewing experience. It would be desirable to be able to use the TV to control lighting, window coverings, etc., to improve the viewing experience.

In addition to issues relating to glare and lighting, consumers with flat panel TVs often have a conflict regarding how the TV should be positioned when off versus on. Typically, the TV is preferably aligned with the wall upon which it is mounted when off, and preferably positioned angled toward the viewer when on for a better viewing and listening experience. For years, automobiles have provided the ability to press a button and have the driver's seat, steering wheel, gas and break pedals all return to a preferred position. It would be desirable to provide a means by which the TV is positioned at the correct angle automatically depending on whether the TV is turned on or off.

Therefore, it would be desirable to provide systems and methods that facilitate an enhanced viewing and listening experience by enabling environmental and positional control.

### SUMMARY

Embodiments described herein are directed to improved systems and methods for enabling centralized environmental and positional control from the TV to enhance the viewing experience. In one embodiment described herein, one or more externally connected environmental controllers, which are used to adjust or control lighting, window coverings, etc., can be selected from a device menu displayed on the TV screen to adjust current environmental settings and optionally save the adjusted setting as a preferred setting. Preferred environmental settings for the environmental controller can also be created and saved in a system setup mode by selecting the environmental controller from a setup menu displayed on the TV screen. Once selected from either menu, an environmental control menu can be provided on the screen that can be operated or navigated using the cursor and select keys and the volume or channel up and down keys on a remote control to open or close window coverings, increase or reduce lighting, etc.

In operation, the TV can cause the environmental controller to implement the preferred environmental settings or settings of last viewing activity (see below) upon start-up or power on and return to a default setting upon power down or off. If configured to return to last view activity setting upon start-up, a delay in activating such settings, e.g., a 30 second delay, is preferably incorporated in the start-up process to give the viewer the opportunity to select an alternative viewing activity. Alternatively, preferred settings can be implemented through selection of menu items or by operation of a dedicated button located on a control panel on the TV or on a remote control unit.

In another embodiment described herein, a positional controller, which is coupled to a TV wall mounting device comprising a motorized or solenoid driven articulating arm, can be selected from a device menu displayed on the screen to adjust the current TV position and optional save the adjusted position as a preferred setting. Preferred settings for the positional controller can also be created in a system setup mode by selecting the positional controller from a setup menu displayed on the TV screen. Once selected from either menu, a positional control menu can be displayed on the TV screen that can be navigated or operated using the cursor and select keys and the volume or channel up and down keys on a remote control to adjust the position of the TV and extend it away from the wall, adjust its height, tilt it toward a viewer, turn it to the left or right, etc. In addition the TV can return to an “off” or neutral position aligned adjacent a wall on which the TV is mounted when the TV is powered off or when selected from a menu or dedicated button on a control panel on the TV or a remote control unit. Similarly, upon power up of the TV, the TV could be returned to a desired viewing position stored in memory during set up and upon power down the TV could return to a position aligned with the wall. Alternatively, one or more position buttons could be provided on the control panel of the TV and/or on the remote control unit to allow the TV to move to a preferred position.

In another alternative embodiment, where the selection of stored positions and environmental settings is menu driven, multiple viewers could have favorite viewing positions and environmental conditions stored for selection.

In another alternative embodiment, preferred environmental and positional settings can be saved to conform to different viewing experiences or activities. For example, activities such as “Watch News”, “Watch a Movie”, “Listen to Music”, “Play Game”, etc. Such viewing activities can be presented in a menu or on the remote and when selected, the TV causes the positional and one or more environmental controllers to implement the preferred positional and environmental settings corresponding to the selected experience or activity. In addition, in a further alternative embodiment, individual audio and video settings could be saved per each activity for the optimized viewing and listening experience for a given activity. For example, the user of a combination device providing gaming and movie capabilities (Playstation 3, XBOX360 and others) could have separate optimized audio and video settings for each activity such as “Play Game” and “Watch Movie”.

In yet another embodiment, a fingerprint sensor or recognition system (FRS) is provided to allow easy selection of personal settings concerning TV position, environmental conditions, favorite channels, advanced user modes, picture/sound and V-Chip settings. In addition, the FRS could be used to unlock V-chip locked channels, programs, etc. In operation, for example, the fingerprints of the adults in the family could be known by the TV and a simple press on a sensor or FRS provided on the TV and/or remote control unit will unlock the V-chip locked TV, adjust the environmental settings to a preferred setting, adjust the TV to a preferred position, and/or adjust other personal settings.

In yet another embodiment, positioning of the TV is conducted using a camera in the TV that identifies the position of the viewer when the viewer operates the TV using a remote control unit. In operation, the camera detects where the very bright IR light that comes from the remote control unit and then the TV causes the positional controller to position the TV to the appropriate viewing angle (horizontally and optionally vertically). The detection mechanism could include a special IR code from the remote control unit that includes a command instructing the camera to take a snapshot of the room while the remote control unit keeps the IR LED on for a duration of time needed for the camera to take the photo. The camera could be a CMOS camera that could also provide a mechanism for measuring the room light temperature and brightness, which data could be used to adjust environmental settings and picture calibration to optimize the picture for the given light conditions.

Other objects, systems, methods, features, and advantages of the example embodiments will be or will become apparent to one with skill in the art upon examination of the following figures and detailed description. It is intended that all such additional systems, methods, features and advantages be included within this description, be within the scope of this invention, and be protected by the accompanying claims. It will be understood that the particular methods and apparatus are shown by way of illustration only and not as limitations. As will be understood by those skilled in the art, the principles and features explained herein may be employed in various and numerous embodiments.

### DESCRIPTION OF THE DRAWINGS

The details of the invention, both as to its structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a schematic of a television system.

FIG. 2A is a schematic of the television screen showing a system setup menu in a graphical user interface.

FIG. 2B is a schematic of the television screen showing a device menu in a graphical user interface.

FIG. 2C is a schematic of the television screen showing an activity selection menu in a graphical user interface.

FIG. 3 is a schematic of the television screen showing a parent lock setup menu.

FIG. 4 is a schematic of the television screen showing a positional control menu in a graphical user interface.

FIG. 5 is a schematic of the television screen showing a environmental control menu in a graphical user interface.

FIGS. 6A and 6B are side views of the television in an “off” position and an “in operation” position.

FIGS. 7A and 7B are top views of the television in an “off” position and an “in operation” position.

FIG. 8 is a top view of a remote control unit.

FIGS. 9 and 10 are flow chart schematics showing system operation utilizing a fingerprint recognition system.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

Embodiments described herein are directed to improved methods and systems for centrally controlling environmental conditions and the position of the television to enhance the viewing experience. As provided in the embodiments described herein, the television system can be setup or programmed to implement preferred environmental and television positional settings upon power up and return to default or neutral settings upon power down or off, adjust and set environmental and television positional settings through a menu-based control system with a graphical user interface, and select preferred settings using the menu-based control system, dedicated function keys or buttons on the television or remote control unit, or a finger print recognition system.

A detailed discussion of a menu-based control system and graphical user interface is provided in U.S. Published Patent Application No. US 2002-0171624 A1, which is incorporated herein by reference. The '624 application describes the menu-based control system and its operation with regard to the centralized control of audio-video components coupled to a television and controlled using a menu-based control system with a graphical user interface. Currently, there are systems that enable remote or centralized control of lighting and other features through IR, RS232 (Lutron, Insteon, X10) or via Zigbee or Z-Wave protocols, and can be utilized in cooperation with the menu-based control system referred to herein to provide centralized environmental and positional control from the television.

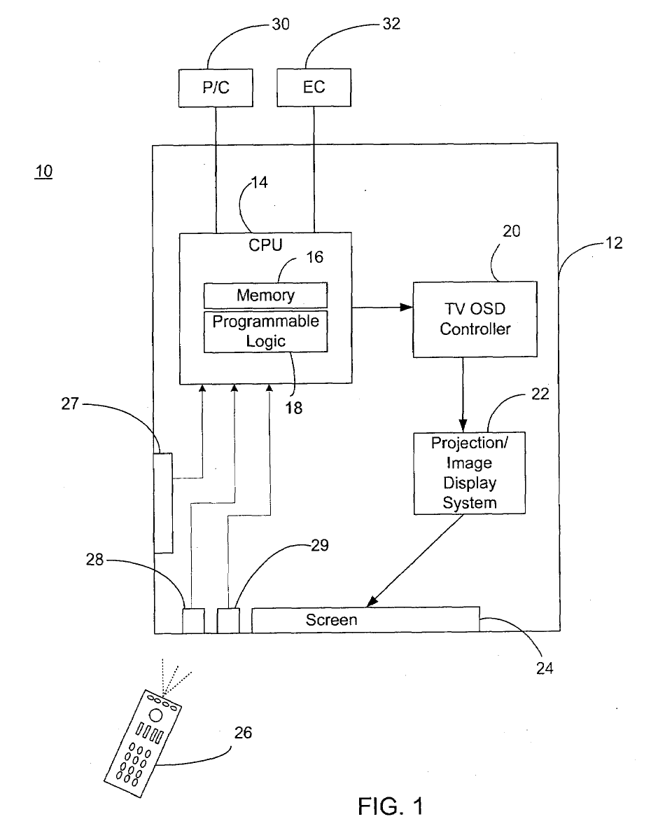

Turning to the figures, the embodiments provided herein are described in detail. A typical television 10, as depicted in FIG. 1, includes an enclosure 12 and a screen 24 housed in or coupled to the enclosure 12. Housed within the enclosure 12 is a central processing unit (CPU) 14 including non-volatile memory 16 and programmable logic 18, which can be in the form of system software stored in memory, integrated circuits, application specific integrated circuit chips and the like. The software preferably comprises a set of instructions to enable the setup and operation of the television system 10. Also housed within the enclosure 12 is an image display system 22, coupled to the screen 24 and an on screen display (OSD) controller 20 coupled to the CPU 14 and the image display system 22. The OSD 20 controls what is displayed on the screen 24.

The television system 10 preferably further includes a remote control device 26 wirelessly coupled to the television 10 to operate and control the television 10. The remote control device 26 can send infra red (IR) signals, radio frequency (RF) signals or the like that are received by a receiver 28 housed in the enclosure 12 and coupled to the CPU 14. The television system 10 can also be controlled through the use of buttons positioned on a control panel 27 located on the enclosure 12 and coupled to the CPU 14.

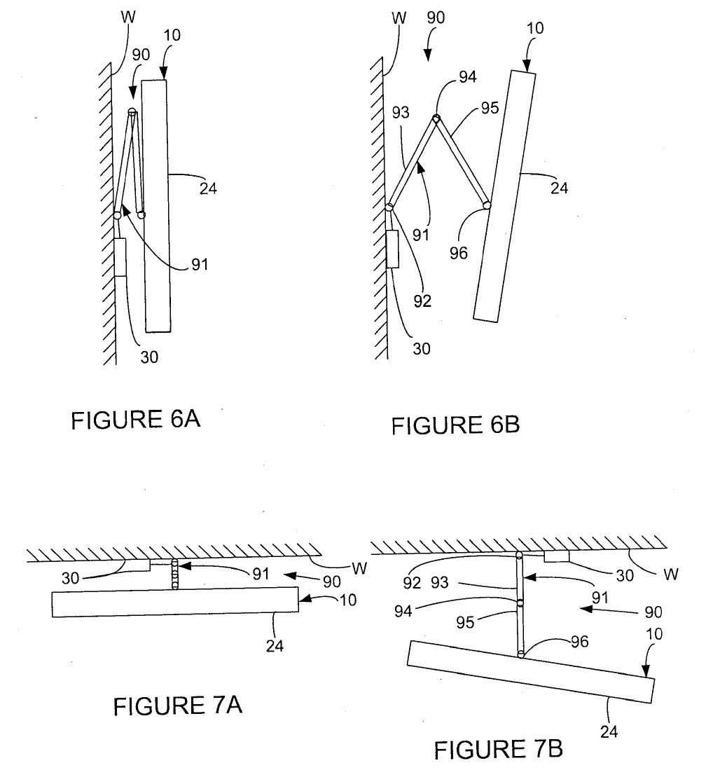

The television system 10 also preferably includes a positional control unit 30 coupled to the CPU 14 and a motorized or solenoid driven articulating arm shown in FIGS. 6A through 7B, and one or more environmental control units 32 coupled to the CPU 14 and the lighting systems, window covering systems, and the like.

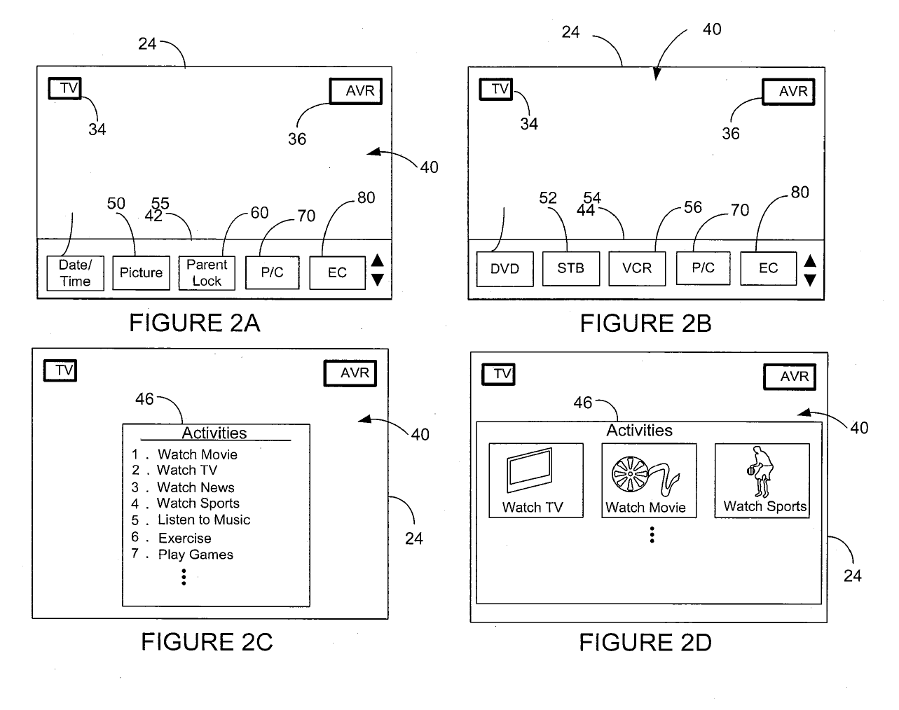

Turning to FIGS. 2A through 4, the graphical user interface (GUI) 40 generated by the CPU 14 is shown displayed on the screen 24. TV and AVR icons 34 and 36 provide the user with a graphical indication of the current video and audio output devises. In FIG. 2A, a system and device setup menu 42 is shown to include selectable icons regarding typical system setup items, such as, e.g., Date/Time 50, Picture 55, Parent Lock 60, and the like, and, in accordance with a preferred embodiment, selectable icons regarding Positional Control (P/C) 70 and Environmental Control 80. FIG. 2B shows a device selection menu 44 including selectable input device icons for a DVD 52, an STB device 54, a VCR 56 and the like, and, in accordance with a preferred embodiment, selectable device icons for a Positional Controller (P/C) 70 and Environmental Controller 80. The setup menu 42 and device selection menu 44 can be operated or navigated using the cursor and select keys and the volume or channel up and down keys on the remote control 26 or on the control panel 27 of the television 10.

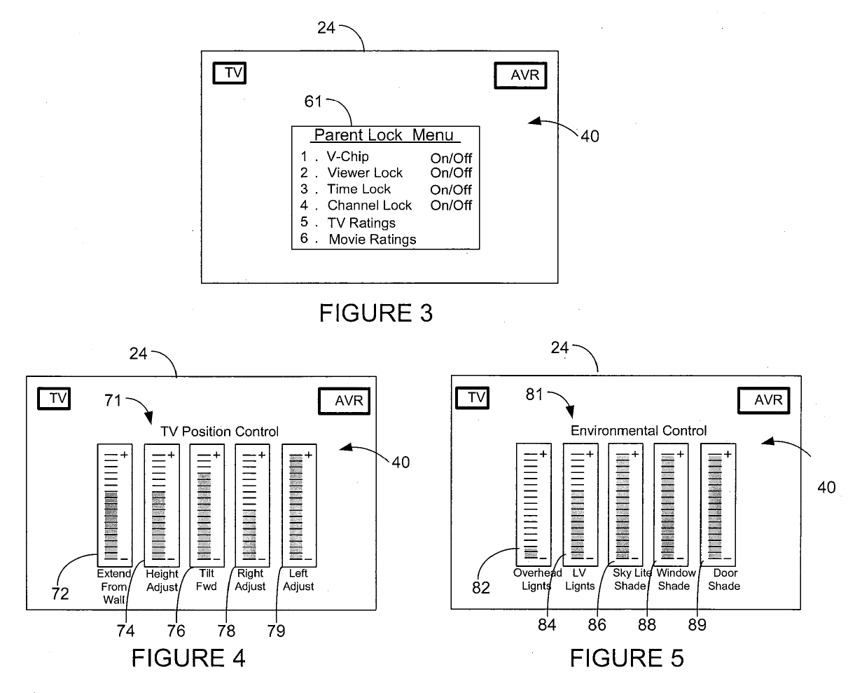

If the Parent Lock icon 60 is selected from the setup menu 42, a Parent Lock Menu 61 is preferably displayed on the screen 24 as depicted in FIG. 3. The Parent Lock Menu 61 can be operated or navigated using the cursor and select keys and the volume or channel up and down keys on the remote control 26 or on the control panel 27 on the television 10 to turn on or off V-Chip control, a Viewer Lock, a Time Lock, a Channel Lock and the like, and set TV and Movie rating levels.

If the Positional Control icon 70 is selected from the setup or device selection menus 42 and 44, a TV Position Control menu 71 is preferably displayed on the screen 24 as depicted in FIG. 4. The Position Control menu 71 can be operated or navigated using the cursor and select keys and the volume or channel up and down keys on the remote control 26 or on the control panel 27 on the television 10 to adjust the position or orientation of the television 10 relative to a wall upon which it is mounted. As depicted, the menu 71 includes an extend from wall control 72, an adjust height control 74, a tilt control 76, a right adjust control 78, a left adjust control 79 and the like.

As shown in FIGS. 6A, 6B, 7A and 7B, a television position control system 90 includes a P/C controller 30 coupled to a motorize or solenoid driven articulating arm 91 moveably coupling the television 10 to a wall W. The articulating arm 91 is shown to include first and second arm members 93 and 95 moveably coupled to one another at pivot joint 94. The first arm member 93 is moveably coupled to the wall W at pivot joint 92 and the second arm member 95 is moveably coupled to the back of the television 10 at pivot joint 96. Pivot joint 96 enables the screen 24 to be tilted toward the viewer or turned to the right or left while the first and second arm members 93 and 95 and pivot joints 92 and 94 cooperate to enable the screen to be extended away from the wall W or retracted toward the wall W, and raised or lowered.

In operation, the television 10 can be returned to an “off” or neutral position aligned adjacent the wall W when the television 10 is powered off or when the neutral position is selected from a menu or when a dedicated function key or button is selected or pressed on the remote control unit 26 or control panel 27 on the television 10. Similarly, upon power up of the television 10, the television 10 could be returned to a desired viewing position stored in memory during set up, and upon power down the television 10 could be returned to a neutral position aligned with the wall W. Alternatively, one or more position buttons could be provided on a control panel 27 of the television 10 or on the remote control unit 26 to cause the positional controller 30 to move the television 10 to one or more preferred positions.

If the Environmental Control icon 80 is selected from the setup or device selection menus 42 and 44, an Environmental Control menu 81 is preferably displayed on the screen 24 as depicted in FIG. 5. The Environmental Control menu 81 can be operated or navigated using the cursor and select keys and the volume or channel up and down keys on the remote control 26 or on the control panel 27 on the television 10 to adjust the room lighting, window and door coverings, and the like. As depicted, the menu 81 includes controls to adjust overhead lights 82, low voltage lights 84, sky lite shades 86, window shades 88, door shades 89, and the like.

In operation, the control system of the television 10 can cause the one or more environmental controllers 32 to implement the preferred environmental settings upon start-up or power on and return to default or neutral settings upon power down or off. Alternatively, preferred settings can be implemented through the selection of menu items or by operation of one or more dedicated function keys or buttons on the remote control unit 26 or a control panel on the television 10.

In another alternative embodiment, where the selection of stored positions and environmental settings is menu driven, multiple viewers could have favorite viewing positions and environmental conditions stored for selection from a menu or through use of a FRS system discussed below.

In another alternative embodiment, preferred environmental and positional settings can be saved to conform to different viewing experiences or activities. For example, activities such as “Watch News”, “Watch Movie”, “Watch Sports”, “Listen to Music”, “Play Games”, etc. Such viewing activities can be presented, as depicted in FIGS. 2C and 2D, in an activities menu 46 on the TV display screen or on the remote control display screen, and when a particular activity is selected, the TV 10 causes the positional controller 30 and the one or more environmental controllers 32 to implement the preferred positional and environmental settings corresponding to the selected activity. Preferably, by selecting a particular activity the TV and connected device will automatically turn-on and implement preferred connections and settings for the activity selected. For example, if “Watch Movie” is selected, the followings actions could take place:

1. Blueray player is powered on;

2. TV is on and Blueray player is selected as input source;

3. Movie video settings are applied;

4. The blinds are closed;

5. The lights are dimmed;

6. The AVR is switched to surround mode;

7. The TV is positioned toward the sofa used for watching movies;

8. The volume is demuted.

In addition, in a further alternative embodiment, individual audio and video settings could be saved per each activity for optimized viewing and listening experience for a given activity. This feature is particular useful where a multi-mode device like a media center PC, Playstation 3, XBOX360 etc. is present and can be used to play a game, watch a movie, view photos, etc., and the user has a desire to setup the activity preferences different per device activity mode, i.e., “Play Game”, “Watch Movie”, etc. When the media center PC gets selected to play a 3D game (“Play Game” in activity menu), the TV preferably goes into it's 3D mode settings, if available. When the media center PC is used to playback a BluRay movie (“Watch Movie” activity menu), the TV implements its movie watching settings and disables the 3D settings in this instance. Thus, the user of a combination device providing gaming and movie capabilities (Playstation 3, XBOX360 and others) could have separate optimized audio and video settings for each activity “Play Game” and “Watch Movie”. Such settings are preferably coupled with the environmental and positional settings.

In yet another alternative embodiment, as depicted in FIG. 1, the TV 10 can have a camera 29 housed in the enclosure 12 and coupled to the CPU 14. The positioning of the TV 10 can be conducted automatically by using the camera 29 to identify the position of the viewer when the viewer operates the TV 10 using a remote control unit 26. In operation, the camera 29 detects where the very bright IR light that comes from the remote control unit 26 and then the TV 10 causes the positional controller 30 to position the TV 10 to the appropriate viewing angle (horizontally and optionally vertically). The detection mechanism could include a special IR code from the remote control unit 26 that includes a command instructing the camera 26 to take a snapshot of the room while the remote control unit 26 keeps the IR LED on for a duration of time needed for the camera 29 to take the photo. The camera 29 could be a CMOS camera that could also provide a mechanism for measuring the room light temperature and brightness, which data could be used to adjust environmental settings and picture calibration to optimize the picture for the given light conditions.

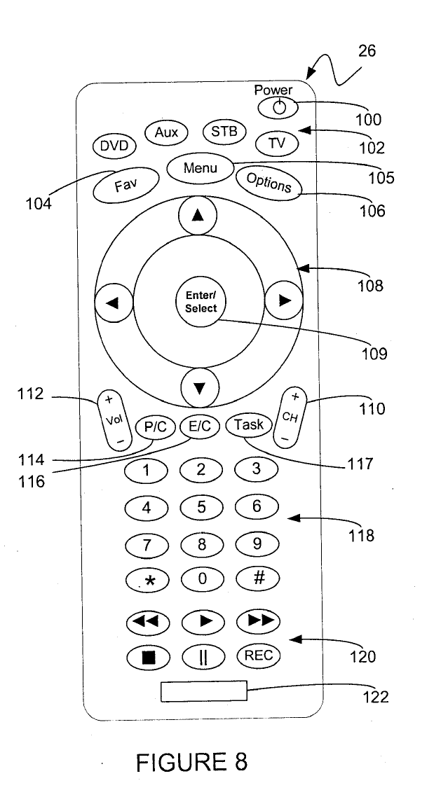

Turning to FIG. 8, the remote control unit 26 is shown to include a power button 100, device control selection keys 102, menu and options control keys 105 and 106 enabling access to setup, device, and activity selection menus (FIGS. 2A, 2B and 2C), cursor and select keys 108 and 109, a volume up and down button 112, a channel up and down button 110, a numeric keypad 118, and a record and playback keypad 120. In addition, the remote control unit 26 preferably includes one or more favorite (FAV) control keys 104 that can be programmed to trigger the implementation of preferred environmental and/or positional settings or cause the display of a favorite or preferred selection menu allowing the user to select different types of preferred settings to implement or activities to conduct.

Other function keys may include a dedicated positional control (P/C) key 114, an environment control (EC) key 116, and/or an activities (Task) key 117. Operation of these keys could trigger the implementation of preferred positional and environment settings or cause the positional, environmental or activity control menus 71, 81 and 46 to be displayed on the screen 24 to allow the user to adjust the current settings or selected a desired activity.

In another embodiment, the remote control unit 26 could include a sensor 122 for a fingerprint recognition system (FRS). The FRS can be used to provide easy selection of personal settings stored in memory concerning television position, environmental settings, favorite channels, advanced user modes, picture/sound and V-Chip settings. For example, upon selecting P/C, EC, activity, V-Chip, etc., the user is prompted to press the FRS sensor 172. Once pressed, the TV causes the stored settings to be implemented or allow access to adjust and store new settings. In addition, the FRS could be used to unlock V-chip locked channels, programs, etc. For example, the fingerprints of the adults in the family could be known by the FRS and a simple press on 122 sensor will unlock the television being V-chip locked, and/or without any additional prompting, adjust the environmental settings to a preferred setting, adjust the television position to a preferred position, and/or adjust other personal settings.

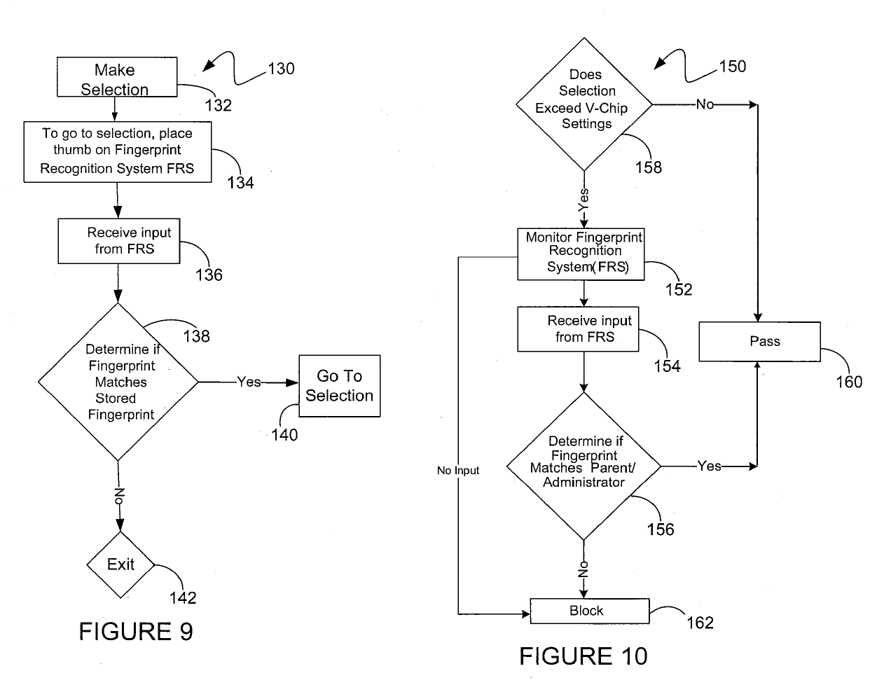

Alternatively, the control system could require authentication of the user in order to access certain menu options or present the user with selection menus of activities or favorite channels associated with the user. As depicted in FIG. 9, once a user makes a selection 132 in a particular menu, such as, e.g., selects the Positional Controller 60 in the device selection menu 44, an authentication process 130 instructs 134 the user to place a thumb over the sensor 122 of the FRS. The control system receives 136 finger print data from the FRS and then determines 138 whether the finger print matches a finger print stored in memory such as the parent or administrator of the system. If the finger print matches, the control system proceeds 140 to the selection. If no match, the control system exits 142 the menu.

In another alternative embodiment, a process 150 using of the FRS in conjunction with V-Chip control is shown in FIG. 10. As depicted, if the viewing is blocked by the V-Chip control, the FRS is monitored 152. If fingerprint input data is received 154 from the FRS, the control system determines 156 whether the finger print matches the parent or administrator of the system. If the finger print matches, the control system passes 160 the video signal to allow viewing of the selected program. If no match, the control system blocks 162 the video signal to prevent viewing of the selected program.

The FRS can also ensure that access to other critical or difficult to configure settings of the televisions is possible only by the installer or administrator of the system. Such restricted access could for example include video settings and other settings that can be time consuming to setup.

In addition, pressing the FRS in itself could directly yield an activity or favorites menu. For example, if the user presses the fingerprint sensor, a favorite channels menu and/or activities menu would be displayed on the screen. Moreover, the children in the family could use the FRS to easily access their favorite channels or activities permitted for them as well as PC and/or EC settings.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

What is claimed is:

1. A television viewing process comprising the steps of
receiving instructions to proceed with a viewing activity selected by a user,
adjusting position of television to positional settings corresponding to the selected viewing activity, and
adjusting environmental settings to environmental settings corresponding to the selected viewing activity.

2. The process of claim 1 further comprising the steps of adjusting television positional settings and environment settings to neutral positional and environmental settings once the viewing activity is complete.

3. The process of claim 1 further comprising the steps of adjusting television positional settings and environment settings to neutral positional and environmental settings when the television is powered off.

4. The process of claim 1 further comprising the steps of prompting the user to select a viewing activity.

5. The process of claim 4 wherein the step of prompting the user to select a viewing activity includes presenting a list of viewing activities in a navigable user interface on a display screen of the television.

6. The process of claim 5 wherein the list is in the form of graphical icons.

7. The process of claim 5 wherein the list of viewing activities include one or more of “watch movie”, “watch TV”, “watch news”, “watch sports”, and “play games”.

8. The process of claim 1 further comprising the steps of retrieving positional settings corresponding to the viewing activity stored in memory in the television.

9. The process of claim 8 further comprising the steps of retrieving environment settings corresponding to the viewing activity stored in memory in the television.

10. The process of claim 9 wherein the environmental settings include one or more of “overhead lights”, “LV lights”, “sky light shade”, “window shade” and “door shade”.

11. The process of claim 1 further comprising the steps of receiving the identity of the viewer that selected the viewing activities.

12. The process of claim 11 wherein the step of adjusting the position of the television includes adjusting the position of the television to positional settings corresponding to the viewer's preference for the selected viewing activity.

13. The process of claim 12 wherein the step of adjusting the environment settings includes adjusting the environment settings to environment settings corresponding to the viewer's preference for the selected viewing activity.

14. The process of claim 13 further comprising the steps of identifying the viewer that selected the viewing activities.

15. The process of claim 14 wherein the step of identifying the viewer includes comparing a viewer specific characteristic to viewer specific characteristics stored in memory.

16. The process of claim 15 wherein the viewer specific characteristic is a finger print.

17. The process of claim 16 further comprising the steps of sensing the viewer's fingerprint at a sensor on the television.

18. The process of claim 17 further comprising the steps of sensing the viewer's fingerprint at a sensor on a remote control unit.
